(19) United States
(12) Patent Application Publication
(10) Pub. No.: US 2007/0135147 A1
(43) Pub. Date: Jun. 14, 2007

(54) Long code mask collision mitigation on networks using pseudo ESNs

(76) Inventors: Daniel J. DeClerck, Lake Barrington, IL (US); William P. Alberth JR., Prairie Grove, IL (US)

Correspondence Address: MOTOROLA, INC., 1303 EAST ALGONQUIN ROAD, IL01/3RD, SCHAUMBURG, IL, 60196, US

(21) Appl. No.: 11/301,125

(22) Filed: Dec. 12, 2005

(51) Int. Cl. H04B 15/00

(52) U.S. Cl. 455/501

(57) ABSTRACT

A cellular communications system capable of detecting long code mask collisions in the reverse link on call setup or call handoff comprises means for assigning a different carrier for the reverse link for one of the duplicate calls, for avoiding interference and dropped calls.

### FIELD OF THE INVENTION

The present invention relates to wireless communications systems, more particularly to mobile phone systems based on code division multiple access (CDMA) technologies.

### BACKGROUND OF THE INVENTION

In a CDMA wireless communications network, subscriber traffic is separated using spreading codes unique to each subscriber. Furthermore, different codes are used to separate forward link channels (base station to subscriber unit) and reverse link channels, which are typically spread on a different carrier as well. While the forward link code (e.g., Walsh code) is typically assigned by the base station at call setup, the reverse link is generated as a function of a pseudo-random code called the “long code” which is then masked with a long code mask unique to each subscriber unit, typically generated as a function of some unique identifier of the subscriber device.

Individual devices in a cellular telecommunications environment have for many years now been identified by a 32-bit code called an Electronic Serial Number (ESN). The 32-bit length of this code allows for a little over 4 billion unique identifiers. ESNs are used to uniquely identify devices in the network environment for communications and in some cases information security. At the time the coding system was implemented, this was considered a sufficient number of unique IDs for purposes of the foreseeable future. Due to explosive growth of cellular networks and devices that use them, and liberal assignment of blocks of ESNs to vendors as well as lax recovery of unused ESNs, the supply of ESNs will soon run out. New device identifiers are being deployed, such as the Mobile Equipment Identification Number (MEID), which provides 56 bits and thus substantially more unique codes. It will take some time to implement such new identifier systems across installed networks, and for a period of time, it will be necessary to support both the old ESN-based systems and the new identifier systems. For example, if a newer cellular device has an MEID but no ESN, and is used in an ESN-based cellular network, a technique must be employed to provide a temporary ESN to the device. Currently, for example, the MEID is used in a hashing function to create a temporary ESN with a valid format, called a pseudo-ESN or pESN.

As a consequence, however, it is now possible that duplicate pESNs may appear in a given cellular network on the same carrier. Since pESNs in particular are used to generate the long code masks, this can result in cross talk and interference between users at the least, and dropped calls in the extreme. Reverse channel traffic in particular is affected because reverse traffic from two subscribers is distinguished solely on the basis of the long code mask. More generally, there may evolve additional circumstances in which the long code mask of two service subscribers is identical. What is needed is a way to accommodate duplicate ESNs and more broadly duplicate long code masks in the cellular networks system when they occur, with minimal disturbance to the cellular device user.

### BRIEF DESCRIPTION OF THE DRAWINGS

FIG. 1 is a flowchart of one embodiment of the present invention;

FIG. 2 is a diagram of a wireless cellular communications network according to an embodiment of the invention; and

FIG. 3 is a diagram of a wireless cellular communications network according to an alternative embodiment of the invention.

### DETAILED DESCRIPTION OF THE EMBODIMENTS

Multiple embodiments of the invention provide for graceful handling of duplicate long code masks, as may be generated from duplicate electronic serial numbers (ESN) or pseudo-ESNs for example, in a cellular telecommunications environment, which duplicates would otherwise result in customers hearing each others' conversations, or even in the phone calls being dropped by the network, with attendant inconvenience to cellular customers. Accordingly, multiple embodiments of the present invention provide that upon detection of duplicate long code masks, one of the detected duplicates is assigned to an alternate carrier, if available. In this way, the possibility of communications interference or dropped calls is mitigated in a multi-carrier environment.

According to one embodiment of the invention, when a new call is setup in a wireless telecommunications cell for, e.g., a mobile station, if its long code mask or ESN duplicates that of a mobile station currently in a call, the base station assigns the new call to at least a distinct reverse link carrier from the carrier of the reverse link of the existing call. In this way, the long code mask of the new call does not result in any interference with the existing call, even though the existing call and the new call are using the same long code mask (on account of duplicate ESNs, for example).

According to another embodiment of the invention, when a handoff of a current call from another cell is requested of a current cell, upon receipt of the long code mask or ESN of the mobile station being handed off, a determination is made whether it duplicates the long code mask or ESN of another mobile station already in a call in the current cell, and if so, the mobile station being handed off is assigned to at least a distinct reverse link carrier from the carrier for the reverse link of the existing call in the current cell.

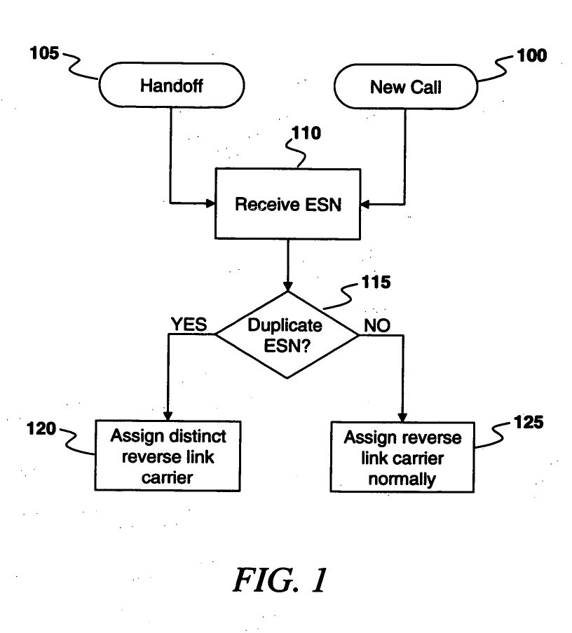

Turning to FIG. 1, a method according to an embodiment of the invention is shown. A new call setup 100 or a call handoff 105 includes the step 110 of receiving at the base station the ESN of a mobile station for which the call is being handled. The ESN can be received for example as part of an access message from the mobile station. In step 115, a determination is made whether the ESN received in step 110 matches an ESN of a mobile station already in a call being handled by the base station. If the received ESN matches the ESN of an existing call, a carrier is assigned for the reverse link of the handoff or new call, which is distinct from the carrier to which the reverse link of the existing call is assigned. If the ESNs don't match, the reverse link carrier of the handoff or new call is assigned as per usual, e.g., without special regard to the reverse link carrier of any other calls.

While a mobile station is described by way of example herein, it should be understood that any wireless terminal station, mobile or otherwise, which utilizes a long code mask that may be duplicated, e.g., by other stations using duplicate pESNs, may be subject to assignment of a distinct reverse link carrier according to multiple embodiments of the invention. Wireless terminal stations which may be used in multiple embodiments of the invention include mobile phones, laptop computers with wireless networking hardware, personal digital assistants with wireless connectivity, wireless communications devices mounted in automobiles, and so on. Further, it should be understood that the test performed in step 115 of duplicate ESNs may also be made directly on the long code masks of mobile stations being serviced in the cell, or on other identifiers used to generate long code masks. For example, it is contemplated the ESN of a mobile station may be received, and upon receipt is used at the base station to generate the long code mask that the mobile station will use to encode its reverse link; and that the long code mask is compared for duplicates, rather than comparing the ESNs. Alternatively, the long code mask itself may be received from the mobile station by the base station as part of an access message for example, and a comparison made to the long code masks of other mobile stations being serviced, without the need to receive the ESN. As yet another example according to multiple embodiments of the invention, the MEID of the mobile station may be transmitted to the base station, and is used to generate the pESN or long code mask that will correspond to the MEID, which can then be checked for duplicates in the cell.

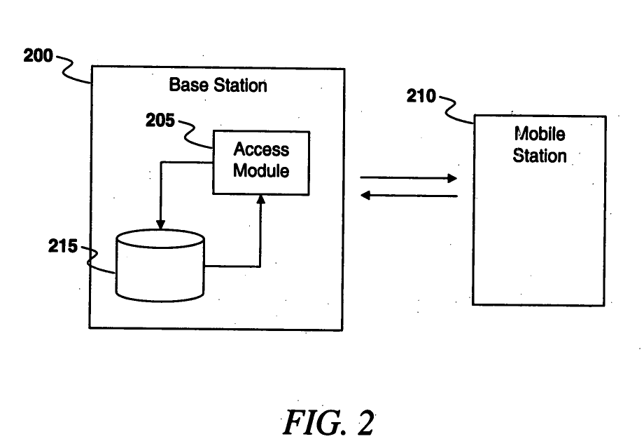

Turning to FIG. 2, a wireless communication network according to an embodiment of the invention includes a base station 200, comprising a module 205 for managing requests for access to or from a mobile station 210. Base station 200 further includes a data store 215 for storing information related to at least the reverse link channel carriers assigned to mobile stations currently in calls in the cell serviced by the base station 200, and optionally information regarding calls being serviced generally, including forward link carrier assignments, call routing information, cell management information, codes, mobile station identifiers and the like. Base station 200 is disposed to receive identifier information from mobile station 210, which is made available to access module 205, which is disposed to look up identifier information in data store 215 related to other mobile stations being serviced, for comparison to the identifier information from mobile station 215. If a duplicate ESN or long code mask or other related identifier is found, the base station assigns a distinct reverse link carrier to the mobile station 210, so that interference with the reverse links of other mobile stations is avoided.

In many embodiments of the present invention, the base station in a wireless communications cell of a CDMA network comprises discrete component electrical circuits, integrated circuits, application specific integrated circuits (ASICs), and/or one or more computers which execute program code, for executing the steps described herein, including for comparing the ESN or long code mask of a mobile station for which a call handoff or new call is being setup, to the ESNs or long code masks registered for other mobile stations currently in calls in that cell, and determining whether a match exists. The base station is further configured to assign a reverse link carrier for the mobile station that is different from the carrier(s) of any other mobile stations having the duplicate ESN or long code mask, and to communicate back to the mobile station with instructions to use that distinct carrier for the reverse link. In this case, the mobile station need not have special circuits or program code to respond to this particular situation, as in any case the mobile station expects to be assigned to some reverse link carrier.

The data store 215 of the base station 200 can be any of a variety of means for storing information in a telecommunications environment, including a register or set of registers in an integrated circuit; dynamic memory in a computing environment; static electronic memory; or a magnetic storage device such as a conventional computer storage disk. The data store can be dedicated to storing information only pertinent to particular embodiments of this invention; or can be the general memory store of the base station used for all kinds of wireless channel management information including the information pertinent to embodiments of the present invention.

Access module 205 can be any of a variety of means useful for accomplishing a computing task, including dedicated circuits comprised of discrete components designed specifically to execute the functions of the module in hardware; or general computing hardware circuits programmatically configured to execute those functions, where said programs can be either a microcode instruction set in registers of an integrated circuit, an instruction set burned into a flash memory or stored in other static memory, or an instruction set in dynamic memory. Furthermore, access module 205 can be a module with functionality dedicated to determining the existence of a match resulting in potentially interfering long code masks pertinent to particular embodiments of the present invention, or can be a module with a larger scope of functionality related to call management, inclusive of determining the existence of such a match. Hence, for example, on the one hand it can be an entire base station computer operating system which includes functionality for determining the existence of matches of wireless terminal station identifiers or long code masks that can potentially result in interference on a channel such as a reverse link, and on the other hand can be a dedicated hardware circuit designed specially for determining such a match.

Base station 200 further comprises specialized circuits or general circuits programmatically configured for assigning a distinct carrier to a call for at least its reverse link, from the carrier of another call in the cell. This can be part of the functionality of the access module 205, or can be executed by other module(s) of the base station. According to one embodiment, access module 205 determines the existence of a duplicate, and also determines what carrier to assign to the reverse link of the new call or handoff, and then notifies other modules that perform the assignment and set up the call or handoff. In another embodiment, access module 205 merely notifies other modules of the existence of a match and the identity and/or carrier of the call being serviced that has a matching long code mask. In yet another embodiment, access module 205 performs call or handoff setup entirely, including assignment of a different reverse link carrier.

Mobile station 210 is shown by way of example, and is not meant to be limiting. As mentioned above, more generally a wireless terminal station communicating with the base station of the cell using a reverse link channel or similar channel can be part of a system embodying the present invention. Wireless devices can include cell phones, PDAs, wireless routers, automobile-mounted wireless devices, and the like used by subscribers/users to transmit and receive information over the wireless network.

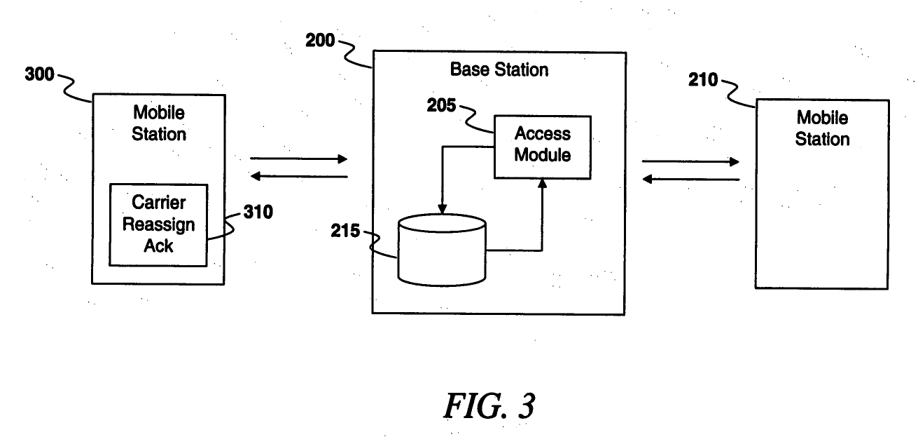

In an alternative embodiment shown in FIG. 3, the wireless communication network of FIG. 2 includes a mobile station 300 comprising a module 310 for receiving and acknowledging reassignment of its reverse link carrier by base station 200. When a new call or a handoff is setup for a mobile station 210, then if access module 205 determines the long code mask of mobile station 210 will duplicate the long code mask of a mobile station 300 already in a call in the cell serviced by base station 200, base station 200 transmits a reassignment to a new reverse link carrier to mobile station 300, and sets up mobile station 210 on the former reverse link carrier of mobile station 300. Module 310 in mobile station 300 initiates the switchover to the reassigned carrier now to be used for the reverse link by mobile station 300 in conducting its ongoing call. Module 310 can comprise specialized hardware circuits for receiving and acknowledging the reassignment, or can comprise general computing circuits programmatically configured to do so. Initiation of the switchover can include utilization of circuitry and or programmatic instructions used in mobile-side management of a conventional call handoff between cells, or can include specialized circuits or programmatic instructions designed for carrier reassignment as described herein within the same cell.

The provision of a distinct reverse link carrier to a second call user in a cellular communications network when the long code mask of the second call would duplicate the long code mask of a first call user in the same cell provides a novel way of avoiding interference, cross-talk and dropped calls that can otherwise occur. While multiple embodiments of the invention has been described above with particular examples and in terms of particular identifiers and comparison steps, these are illustrative and not meant to limit the scope of the invention, which can be understood to apply generally to systems containing wireless terminal stations and devices which use a long code mask or its equivalent to encode at least one channel of bidirectional traffic in a cellular communications system, and where more than one carrier is available for assignment of these traffic channels.

What is claimed is:

1. A method for mitigating interference between two users of a wireless telecommunications network, comprising the steps of:
detecting a first unique identifier of a first user in a telecommunications cell of said network;
detecting a second unique identifier of a second user in the cell;
determining whether said first unique identifier and said second unique identifier match;
assigning at least one channel of the second user to a carrier different from a carrier assigned to said first user.

2. A method according to claim 1, wherein the telecommunications network comprises a Code Division Multiple Access (CDMA) network.

3. A method according to claim 2, wherein said channel is a reverse link.

4. A method according to claim 3, wherein said first unique identifier determines a long code mask.

5. A method according to claim 4, wherein said first unique identifier comprises a long code mask.

6. A method according to claim 4, wherein said first unique identifier is an Electronic Serial Number (ESN).

7. A method according to claim 4, wherein said first unique identifier is derived from a Mobile Equipment Identifier (MEID).

8. A method according to claim 7, wherein said first unique identifier is a pseudo ESN.

9. A method according to claim 1, wherein said step of detecting a second unique identifier comprises detecting said second unique identifier during call setup for said second user.

10. A method according to claim 1, wherein said step of detecting a second unique identifier comprises detecting said second unique identifier during a call handoff.

11. A Code Division Multiple Access (CDMA) wireless communication apparatus, comprising a processing platform configured and arranged to:
determine whether a first wireless station accessing a cell in a cellular network has a unique identifier matching a second wireless station being serviced in said cell; and
assign at least one channel for said first wireless station to a different carrier than that of said second wireless station, responsive to determining that the unique identifier matches the second wireless station.

12. An apparatus according to claim 11, wherein said channel is a reverse link channel.

13. An apparatus according to claim 12, wherein said unique identifier determines a long code mask.

14. An apparatus according to claim 13, wherein said unique identifier is derived from a Mobile Equipment Identifier (MEID).

15. An apparatus according to claim 11, wherein the processing platform comprises:
a data store for storing said unique identifiers of wireless stations being serviced in said cell; and
means for determining a match between the unique identifier received from said first wireless station and the unique identifier of said second wireless station stored in said data store.

16. An apparatus according to claim 15 wherein the processing platform further comprises means for assigning a channel for said first wireless station to a different carrier than that of said second wireless station, responsive to a determination that the unique identifier matches that of the second wireless station.

17. An apparatus according to claim 11, wherein the processing platform is further configured and arranged to determine whether a match occurs during call handoff into said cell for said first wireless station.

18. A mobile station for use in a Code Division Multiple Access (CDMA) cellular telecommunications network, comprising:
means for receiving from a cellular base station an indication that the mobile station has a duplicate identifier in a cell in said network; and
means for facilitating selection of an alternate carrier in said cell responsive to the receiving means receiving said indication.

19. A mobile station according to claim 18, wherein said means for facilitating selection of an alternate carrier is disposed to initiate a switchover from an original carrier assigned by said base station to an alternate carrier assigned by said base station.

20. A mobile station according to claim 19, wherein said original carrier and said alternate carrier carry a reverse link channel.
